(19) United States
(12) Patent Application Publication
(10) Pub. No.: US 2026/0138616 A1
(43) Pub. Date: May 21, 2026

(54) BATTERY HEATING APPARATUS

(71) Applicant: SUBARU CORPORATION, Tokyo (JP)

(72) Inventors: Kimihiro NAGASE, Tokyo (JP); Takumi ARAKI, Tokyo (JP)

(21) Appl. No.: 19/371,405

(22) Filed: Oct. 28, 2025

(30) Foreign Application Priority Data
Nov. 20, 2024 (JP) 2024-202781

(51) Int. Cl. B60W 30/192; B60W 10/08; B60W 10/188; B60W 10/26; F01P 5/12; H01M 10/48; H01M 10/615; H01M 10/625; H01M 10/633; H01M 10/6568; H01M 10/663; H02K 9/19

(52) U.S. Cl. CPC B60W 30/192; B60W 10/08; B60W 10/188; B60W 10/26; F01P 5/12; H01M 10/486; H01M 10/615; H01M 10/625; H01M 10/633; H01M 10/6568; H01M 10/663; H02K 9/19; B60W 2510/246; B60W 2710/08; B60W 2710/182; H01M 2220/20

(57) ABSTRACT

A battery heating apparatus includes an electric motor, hydraulic brakes, a battery, a heat exchanger, a rotation detector configured to detect rotation of the electric motor, and a control unit. The control unit performs: supplying, when predetermined heat generation start conditions are satisfied, electric power to the electric motor while driving the electric brake booster, and, after an elapse of a predetermined period of time, stopping the driving of the electric brake booster and performing a heat generation availability determination; repeatedly performing, when the electric motor has not rotated, the heat generation availability determination while increasing the electric power to be supplied to the electric motor; and stopping, when the power supplied to the electric motor reaches predetermined target electric power, driving the electric brake booster and performing heat generation for maintaining a state in which the predetermined target electric power is supplied to the electric motor.

### CROSS-REFERENCE TO RELATED APPLICATIONS

The present application claims priority from Japanese Patent Application No. 2024-202781 filed on Nov. 20, 2024, the entire contents of which are hereby incorporated by reference.

### BACKGROUND

The disclosure relates to a battery heating apparatus.

In recent years, battery electric vehicles (BEVs), which use an electric motor as a source of driving force and emit no exhaust gases, have been put into practical use. In such electric vehicles, a high-voltage battery (hereinafter simply referred to as a “battery”) for supplying electric power to the electric motor (or receiving and storing regenerated electric power) is mounted.

Batteries have a tendency (characteristic) for higher internal resistance and lower charge-discharge performance as the temperature drops. Therefore, when ambient temperature is low and a battery is cold, for example, charging time increases, and it is difficult for the battery to deliver high output. Some BEVs, therefore, are known to have a motor-based heat generation function, by which, while a vehicle is stationary (parked), electric power is supplied to an electric motor (the electric motor is energized) and a battery is heated (temperature is increased) using heat generated by the electric motor.

Here, for example, Japanese Unexamined Patent Application Publication (JP-A) No. 2022-161629 describes a technique for preventing vehicle movement due to torque of a rotary electric machine exceeding parking brake holding torque by suppressing unintended generation of large torque in the rotary electric machine, which is caused by a sudden inflow of a large current into the rotary electric machine, when performing heating control (motor-based heat generation) while the vehicle is stationary.

### SUMMARY

An aspect of the disclosure provides a battery heating apparatus including an electric motor, hydraulic brakes, a battery, a heat exchanger, rotation detector, a temperature detector, and a control unit. The electric motor is configured to drive wheels via a drive system that is not provided with a parking gear and a parking brake. The hydraulic brakes include an electric brake booster configured to generate brake hydraulic pressure using a drive motor, and are configured to brake the wheels using the brake hydraulic pressure. The battery is configured to supply electric power to the electric motor. The heat exchanger is configured to exchange heat between the electric motor and the battery. The rotation detector is configured to detect rotation of the electric motor. The temperature detector is configured to detect temperature of the battery. The control unit is configured to control the electric motor and the electric brake booster. The control unit is configured to perform a process including: supplying, when predetermined heat generation start conditions including a condition that a vehicle be parked and a condition that the temperature of the battery be lower than or equal to a predetermined temperature are satisfied, electric power to the electric motor while driving the electric brake booster, and, after an elapse of a predetermined period of time, stopping the driving of the electric brake booster and performing a heat generation availability determination for determining whether the electric motor has rotated during and after the driving of the electric brake booster; repeatedly performing, when the electric motor has not rotated, the heat generation availability determination while increasing the electric power to be supplied to the electric motor; and stopping, when the power supplied to the electric motor reaches predetermined target electric power, driving the electric brake booster and performing heat generation for maintaining a state in which the predetermined target electric power is supplied to the electric motor.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a block diagram illustrating configuration of a battery heating apparatus and an all-wheel drive battery electric vehicle for which the battery heating apparatus is employed according to an embodiment of the disclosure;

FIG. 2 is a diagram illustrating configuration of a heat exchange system constituting the battery heating apparatus according to the embodiment;

FIG. 3 is a flowchart illustrating a procedure of motor-based heat generation (a heat generation availability determination and heat generation) by the battery heating apparatus according to the embodiment; and

FIG. 4 is a timing chart illustrating changes in a heat generation instruction flag, an electric oil pump flow rate, a motor instruction current, a braking instruction, and battery temperature during the motor-based heat generation (the heat generation availability determination and the heat generation) by the battery heating apparatus according to the embodiment.

### DETAILED DESCRIPTION

As described above, with the technique described in JP-A No. 2022-161629, it is possible to suppress vehicle movement due to torque of a rotary electric machine exceeding parking brake holding torque during heating control (motor-based heat generation) while a vehicle is stationary. In the case of, for example, a vehicle in which a drive system that transmits driving force of an electric motor to wheels is not provided with a parking gear, a parking brake, and the like, however, the wheels might rotate (or idle) if the motor-based heat generation is performed using the electric motor while the vehicle is stationary (parked). When a dedicated parking gear, a dedicated parking brake, or the like is newly added, on the other hand, cost, weight, and the like increase. In addition, because an electric brake booster is thermally limited for long-duration operation, it is difficult to continuously drive the electric brake booster during the motor-based heat generation.

It is desirable to provide a battery heating apparatus capable of performing motor-based heat generation while a vehicle is stationary (parked) without adding a dedicated parking gear, a dedicated parking brake, or the like even when a parking gear, a parking brake, and the like are not provided for a drive system that transmits driving force of an electric motor to wheels.

An embodiment of the disclosure will be described in detail hereinafter with reference to the drawings. In the drawings, the same or corresponding parts are denoted by the same reference signs. In the drawings, the same elements are given the same reference signs, and redundant description thereof is omitted. The present embodiment will be described while assuming, as an example, a case where the disclosure is applied to an all-wheel drive battery electric vehicle (AWD BEV).

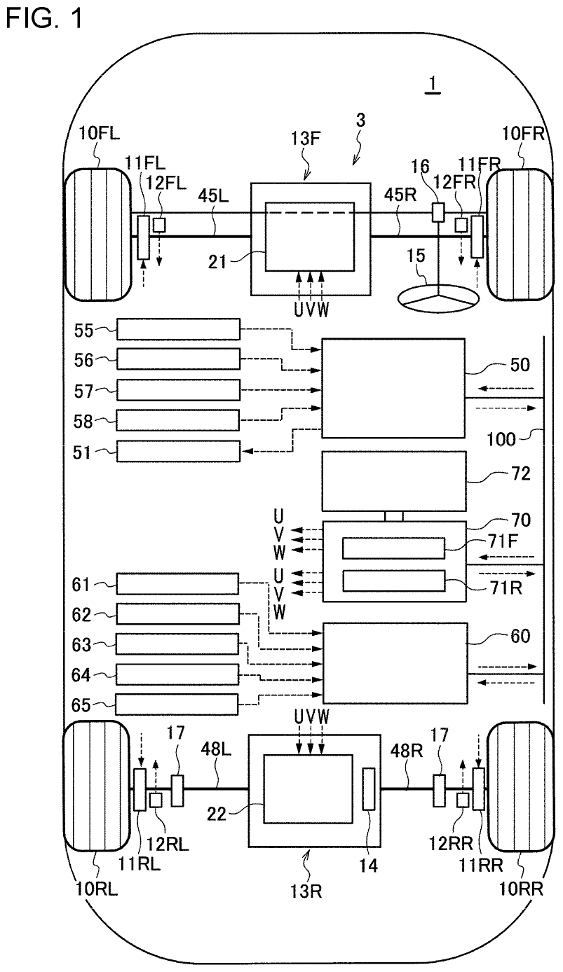

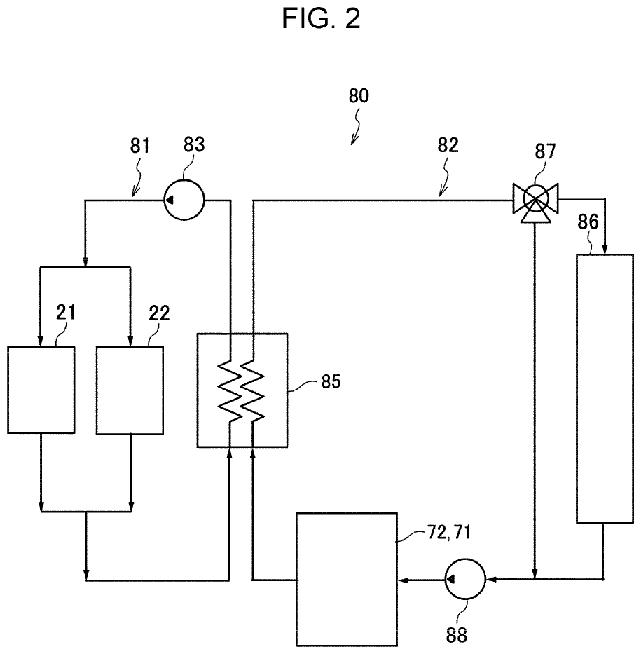

First, configuration of a battery heating apparatus (motor-based heat generation system) 3 according to the embodiment will be described with reference to FIGS. 1 and 2. FIG. 1 is a block diagram illustrating configuration of the battery heating apparatus 3 and an AWD BEV 1 (hereinafter simply referred to as a “vehicle 1”) for which the battery heating apparatus 3 is employed. FIG. 2 is a diagram illustrating configuration of a heat exchange system 80 constituting the battery heating apparatus 3.

A front motor-generator (FMG) 21 (corresponds to a first electric motor described in an aspect) is, for example, coupled to left and right front wheels 10FL and 10FR via a drive system 13F including a reduction gear (or a transmission), a front differential (not illustrated), and left and right drive shafts 45L and 45R to transmit torque to the front wheels 10FL and 10FR. The torque output from the FMG 21, therefore, is converted by the reduction gear and transmitted to the front wheels 10FL and 10FR via the front differential and the left and right drive shafts 45L and 45R. That is, the FMG 21 is coupled to the front wheels 10FL and 10FR and drives the front wheels 10FL and 10FR.

Similarly, a rear motor-generator (RMG) 22 (corresponds to a second electric motor described in the aspect) is, for example, coupled to left and right rear wheels 10RL and 10RR via a drive system 13R including a reduction gear (or a transmission), a rear differential (not illustrated), and left and right drive shafts 48L and 48R to transmit torque to the rear wheels 10RL and 10RR. The torque output from the RMG 22, therefore, is converted by the reduction gear and transmitted to the left and right rear wheels 10RL and 10RR via the rear differential and the left and right drive shafts 48L and 48R. That is, the RMG 22 is coupled to the rear wheels 10RL and 10RR and drive the rear wheels 10RL and 10RR.

The drive system 13R that transmits driving force of the RMG 22 to the rear wheels 10RL and 10RR is provided with a parking gear 14 and an electric parking brake (EPB) 17. For example, the parking gear 14 is fitted to an output shaft of the reduction gear. When a parking (P) range is selected, for example, a parking pawl engages with the parking gear 14 to lock the parking gear 14 so that the rear wheels 10RL and 10RR do not rotate.

The EPB 17 includes an electric actuator, for example, and when predetermined operation conditions including an operation by a driver who drives the vehicle 1 (an operation for turning on an EPB switch etc.) are satisfied, the EPB 17 drives the electric actuator to brake the rear wheels 10RL and 10RR of the vehicle 1 and maintain a stationary state of the vehicle 1. Although the EPB 17 is an inner drum (drum-in disc) EPB including a small drum brake for a parking brake in a hub in the present embodiment, a different EPB may be used, instead. When the motor-based heat generation is performed, an electric vehicle control unit (EV-CU) 60, which will be described later, may automatically turn on the EPB 17 and lock the parking gear 14 (parking mechanism).

The drive system 13F that transmits driving force of the FMG 21 to the front wheels 10FL and 10FR, on the other hand, is not provided with a parking gear (parking mechanism) and an EPB.

The FMG 21 and the RMG 22 are, for example, configured as synchronous motor-generators (three-phase alternating current (AC) synchronous motors) that have both a function as a synchronous motor that converts supplied electric power (three-phase AC) into mechanical power and a function as a generator that converts input mechanical power into electric power. That is, each of the FMG 21 and the RMG 22 operates a synchronous motor that generates driving torque when driving the vehicle 1, and operates as a generator during regeneration. The EV-CU 60, which will be described later, controls the FMG 21 and the RMG 22.

The FMG 21 is coupled to a battery 72 via a front inverter 71F, and the RMG 22 is coupled to the battery 72 via a rear inverter 71R. The front inverter 71F may be, for example, integrated with the FMG 21, the reduction gear, the front differential, and the like. Similarly, the rear inverter 71R may be integrated with the RMG 22, the reduction gear, the front differential, and the like.

When the FMG 21 and the RMG 22 function as motors, the front inverter 71F and the rear inverter 71R (hereinafter collectively referred to as inverters 71) convert direct current (DC) power (current) supplied from the battery 72 into AC power (current) and drive the FMG 21 and the RMG 22, respectively. When the FMG 21 and the RMG 22 function as generators, the front inverter 71F and the rear inverter 71R convert AC power generated by the FMG 21 and the RMG 22 into DC power and charge the battery 72.

That is, the battery 72 supplies electric power to the FMG 21 and the RMG 22, which are sources of driving force of the vehicle 1, or receives and stores regenerated electric power. A lithium-ion battery, for example, may be used as the battery 72.

A temperature sensor 64 (corresponds to a temperature detector described in the aspect) that detects temperature of the battery 72 is mounted on the battery 72. The temperature sensor 64 is coupled to the EV-CU 60, which will be described later, and the EV-CU 60 reads an electrical signal (voltage value) corresponding to the battery temperature. A thermistor whose resistance value varies depending on the temperature, for example, may be used as the temperature sensor 64.

Hydraulic brakes 11FL to 11RR (hereinafter collectively referred to as brakes 11) that brake the wheels 10FL and 10RR are attached to the wheels 10FL to 10RR (hereinafter collectively referred to as wheels 10), respectively. Wheel speed sensors 12FL to 12RR (hereinafter collectively referred to as wheel speed sensors 12) that detect wheel rotation speed are attached to the wheels 10FL to 10RR, respectively.

The wheel speed sensors 12 are noncontact sensors that detect changes in magnetic fields of rotors (gear rotors or magnetic rotors) that rotate together with the wheels 10, and, for example, a method for detecting rotor rotation using magnetic pickups, Hall elements, magnetoresistive (MR) elements, or the like may be used. The wheel speed sensors 12 are coupled to the EV-CU 60, which will be described later. The wheel speed sensors 12 may be coupled to a vehicle dynamics control unit (VDCU) 50, which will be described later.

Since the vehicle 1 is configured as described above, the FMG 21 directly drives the front wheels 10FL and 10FR and the RMG 22 directly drives the rear wheels 10RL and 10RR. The driving force of the FMG 21 and the driving force of the RMG 22 are controlled for balance, and the driving force for the front and rear wheels 10 is variably distributed. During braking or the like, the FMG 21 and the RMG 22 can be used for regeneration.

The FMG 21 and the RMG 22 are oil-cooled electric motors. The heat exchange system (temperature adjusting system) 80 appropriately adjusts temperatures of the FMG 21, the RMG 22, the battery 72, the front inverter 71F, the rear inverter 71R, and the like. As illustrated in FIG. 2, the heat exchange system (temperature adjusting system) 80 mainly includes an oil circulation system 81, a coolant circulation system 82, and a heat exchanger 85.

The oil circulation system (motor cooling system) 81 mainly includes an electric oil pump 83, the FMG 21, and the RMG 22. The electric oil pump 83 pressurizes and discharges oil to forcibly circulate the oil. The electric oil pump 83 sends the oil cooled by the heat exchanger 85 to the FMG 21 and the RMG 22. The oil that has cooled the FMG 21 and the RMG 22 (that is, the oil heated by the FMG 21 and the RMG 22) is sent to the heat exchanger 85, where heat is exchanged between the oil and a coolant.

The coolant circulation system (battery temperature adjusting system) 82 mainly includes an electric water pump 88, a radiator 86, the battery 72, the front inverter 71F, the rear inverter 71R, and a switching valve 87. The electric water pump 88 pressurizes and discharges the coolant to forcibly circulate the coolant. The radiator 86 exchanges heat between the coolant and the atmosphere (that is, dissipates the heat of the coolant to the outside). The switching valve 87 operates in accordance with temperature of the coolant to switch a pipe (flow path) through which the coolant flows. For example, during warm-up, the switching valve 87 switches the flow path of the coolant in such a way as to bypass the radiator 86, thereby promoting the warm-up. When the temperature of the coolant is low, therefore, the coolant circulates while bypassing the radiator 86. During the motor-based heat generation, which will be described later, the coolant circulates while bypassing the radiator 86.

The heat exchanger 85 exchanges heat between the oil that has cooled the FMG 21 and the RMG 22 and the coolant for adjusting the temperature of the battery 72.

Referring back to FIG. 1, the EV-CU 60 comprehensively controls driving of the FMG 21, the RMG 22, an electric brake booster (drive motor) 51, the electric oil pump 83, the electric water pump 88, and the like. The EV-CU 60 is communicably coupled, via a controller area network (CAN) 100, to the VDCU 50 that improves driving stability of the vehicle 1 by suppressing lateral slip.

The EV-CU 60 and the VDCU 50 include a microprocessor for processing, an electrically erasable programmable read-only memory (EEPROM) storing programs for causing the microprocessor to perform various types of processing, a random-access memory (RAM) storing various types of data such as results of processing, a backup RAM holding the various types of data, and input and output interfaces.

The VDCU 50 is coupled to, for example, a steering angle sensor 16, a forward and rearward acceleration (forward and rearward G) sensor 55, lateral acceleration (lateral G) sensor 56, a yaw rate sensor 57, and a brake switch 58. The forward and rearward acceleration sensor 55 detects acceleration in forward and rearward directions acting on the vehicle 1, and the lateral acceleration sensor 56 detects acceleration in a lateral direction acting on the vehicle 1. The steering angle sensor 16 detects a rotation angle of a pinion shaft to detect steering angles of the front wheels 10FL and 10FR (that is, a steering angle of a steering wheel 15), which are steered wheels. The yaw rate sensor 57 detects a yaw rate of the vehicle 1.

The VDCU 50 drives the hydraulic brakes 11 in accordance with the amount of operation of a brake pedal (depression) to brake the vehicle 1, detects vehicle behavior using various sensors (for example, the wheel speed sensors 12, the steering angle sensor 16, the forward and rearward acceleration sensor 55, the lateral acceleration sensor 56, the yaw rate sensor 57, etc.), and suppresses lateral slip through brake control and motor torque control based on automatic pressurization using the electric brake booster 51 to secure vehicle stability during turning. That is, for example, the VDCU 50 suppresses lateral slip and secures excellent driving stability when the vehicle's posture (behavior) becomes unstable during entry into a corner at excessive speed or abrupt steering maneuvers.

The VDCU 50 also brakes the vehicle 1 (wheels 10) by driving the electric brake booster 51 (that is, by driving the hydraulic brakes 11) in accordance with a braking request (details will be described later) from the EV-CU 60 during the motor-based heat generation. The electric brake booster 51 drives the hydraulic brakes 11 by, for example, pressurizing a primary piston using drive motor power and generating brake hydraulic pressure. Because the electric brake booster 51 is thermally limited for long-duration operation, it is difficult to continuously drive the electric brake booster 51 throughout the motor-based heat generation, which will be described later.

The VDCU 50 transmits the detected steering angle, the forward and rearward acceleration, the lateral acceleration, the yaw rate, the braking information, and the like to the EV-CU 60 via the CAN 100. The VDCU 50, on the other hand, receives braking request information and the like from the EV-CU 60 via the CAN 100.

The EV-CU 60 is coupled to, for example, various sensors including an accelerator sensor 61 that detects depression of an accelerator pedal (amount of operation of the accelerator pedal), a resolver 62 (corresponds to a rotation detector described in the aspect) that detects a rotational position (speed) of the FMG 21, a resolver 63 (corresponds to a rotation detector described in the aspect) that detects a rotational position (speed) of the RMG 22, and the above-described wheel speed sensors 12 that detect the speed of the wheels 10. The EV-CU 60 is also coupled to the above-described temperature sensor 64 that detects the temperature of the battery 72. The EV-CU 60 is also coupled to an oil temperature sensor 65 that detects temperature of the oil (oil temperature), and the EV-CU 60 reads an electrical signal (voltage value) corresponding to the temperature of the oil (oil temperature). A thermistor whose resistance value varies depending on the temperature, for example, may be used as the oil temperature sensor 65.

The EV-CU 60 also reads, directly or from a power control unit (PCU) 70, which will be described later, via the CAN 100, values of currents flowing through the FMG 21 and the RMG 22 detected by current sensors.

The EV-CU 60 receives various types of information including the steering angle, the forward and rearward acceleration, the lateral acceleration, the yaw rate, and the braking information, for example, from the VDCU 50 via the CAN 100.

The EV-CU 60 comprehensively control the driving of the FMG 21 and the RMG 22 based on the obtained various types of information. The EV-CU 60 obtains a target torque (torque instruction value) of each of the FMG 21 and the RMG 22 based on, for example, the amount of operation of the accelerator pedal (driving force requested by the driver), an operation state (vehicle speed etc.) of the vehicle 1, and a state of charge (SOC) of the battery 72. As described above, the EV-CU 60 controls the electric brake booster 51, the electric oil pump 83, the electric water pump 88, and the like as described above. That is, in an embodiment of the disclosure, the EV-CU 60 serves as a control unit.

At this time, the EV-CU 60 adjusts (controls) output torques of the FMG 21 and the RMG 22, for example, in such a way as to achieve front and rear driving force distribution according to frictional force between the front and rear wheels 10FL, 10FR, 10RL, and 10RR and a road surface. The EV-CU 60 obtains ground contact loads of the front wheels 10FL and 10FR and the rear wheels 10RL and 10RR from the forward and rearward acceleration and the lateral acceleration of the vehicle 1, for example, and estimates the frictional force in relation to the road surface based on the ground contact loads.

The PCU 70 drives the FMG 21 and the RMG 22 via the front inverter 71F and the rear inverter 71R based on the target torques (torque instruction values). Here, the front inverter 71F and the rear inverter 71R convert DC power (current) of the battery 72 into three-phase AC power (current), and supply the three-phase AC power to the FMG 21 and the RMG 22, respectively. The front inverter 71F and/or the rear inverter 71R, on the other hand, convert AC power generated by the FMG 21 and/or the RMG 22 into DC power to charge the battery 72.

The battery 72 has a tendency (characteristic) for higher internal resistance and lower charge-discharge performance as the temperature drops. Therefore, when ambient temperature is low and the battery 72 is cold, for example, charging time increases, and it is difficult for the battery 72 to deliver high output.

The EV-CU 60, therefore, has a function of performing the motor-based heat generation while the vehicle 1 is stationary (parked) without newly adding a dedicated parking gear, a dedicated parking brake, or the like even when the drive system 13F, which transmits driving force of the electric motor (the FMG 21 in the present embodiment) to the wheels 10 (the front wheels 10FL and 10FR in the present embodiment), is not provided with a parking gear, a parking brake, and the like. That is, the EV-CU 60 performs the motor-based heat generation using the FMG 21 in addition to the RMG 22. In the EV-CU 60, the microprocessor executes a program stored in the EEPROM or the like to achieve the function. The FMG 21 will be mainly described hereinafter.

When predetermined heat generation start conditions including a condition that the vehicle 1 be parked (stationary) and a condition that the temperature of the battery 72 be lower than or equal to a predetermined temperature (for example, 0° C.) are satisfied, the EV-CU 60 supplies electric power (current) to the FMG 21 while driving the electric brake booster 51 (hydraulic brakes 11), and, after an elapse of a predetermined period of time (for example, several seconds to tens of seconds), stops driving the electric brake booster 51 and performs a heat generation availability determination for determining whether the FMG 21 (or the wheels 10) has rotated during and after the driving of the electric brake booster 51.

At this time, the EV-CU 60 drives the electric oil pump 83 to achieve a discharge flow rate sufficient to wet the entirety of a stator of the FMG 21. The predetermined period of time may be set in consideration of thermally permissible continuous operation time of the electric brake booster 51.

If the FMG 21 (or the wheels 10) has not rotated, the EV-CU 60 drives, after a predetermined period of time elapses (that is, after the temperature of the electric brake booster 51 falls below a predetermined temperature), the electric brake booster 51 (hydraulic brakes 11) again, increases (adds on) electric power (current) to be supplied to the FMG 21 by a predetermined amount, stops driving the electric brake booster 51 after the elapse of another predetermined period of time, and determines whether the FMG 21 (or the wheels 10) has rotated during and after the driving of the electric brake booster 51 (performs the heat generation availability determination). That is, the EV-CU 60 attempts to determine that the FMG 21 has operated as instructed after the increase of the supplied electric power (current) and that the FMG 21 has not rotated (for example, a rotor phase angle fluctuation [deg] or [deg/sec] is smaller than or equal to a predetermined angle (threshold)).

If the FMG 21 (wheels 10) has not rotated, the EV-CU 60 increases the electric power (current) to be supplied to the FMG 21 (adds a predetermined value), and repeatedly performs the heat generation availability determination.

When the electric power (current) supplied to the FMG 21 reaches predetermined target electric power (current), the EV-CU 60 continuously performs heat generation for maintaining a current state, that is, a state in which the driving of the electric brake booster 51 has been stopped and the predetermined target electric power (current) is supplied to the FMG 21, until the temperature of the battery 72 reaches a predetermined target temperature. Here, the heat generation availability determination and the heat generation will be collectively referred to as motor-based heat generation. The predetermined target electric power (current) may be set in consideration of, for example, a temperature requirement and the like.

Thereafter, when the temperature of the battery 72 reaches the predetermined target temperature, the EV-CU 60 stops supplying electric power to the FMG 21, and ends the motor-based heat generation including the heat generation availability determination and the heat generation.

If the FMG 21 (or wheels 10) has rotated by a predetermined angle or more while the motor-based heat generation (the heat generation availability determination or the heat generation) is being performed, on the other hand, the EV-CU 60 immediately stops supplying electric power to the FMG 21 to stop the rotation the FMG 21 (that is, the rotation of the front wheels 10FL and 10FR) and abort the motor-based heat generation (the heat generation availability determination or the heat generation). The predetermined angle may be set in consideration of, for example, an angle at which backlash of gears and other components constituting the drive system 13F of the FMG 21 is taken up.

The EV-CU 60 may increase the discharge flow rate of the electric oil pump 83 as the electric power (current) supplied to the FMG 21 is increased (as the temperature of the FMG 21 increases). For example, during the heat generation availability determination, the discharge flow rate of the electric oil pump 83 may be decreased, and during the heat generation, the discharge flow rate of the electric oil pump 83 may be increased.

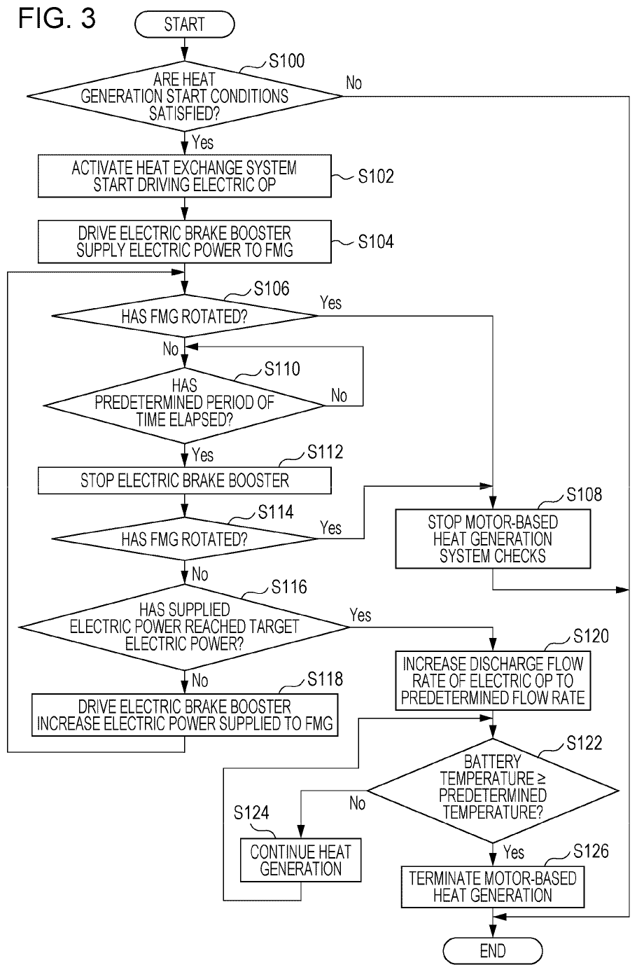

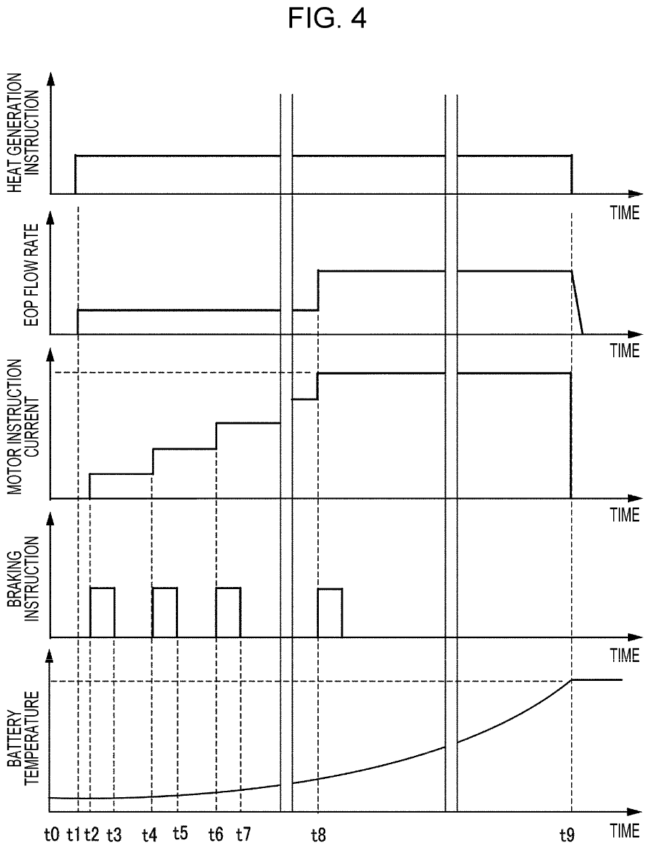

Next, operation of the battery heating apparatus (motor-based heat generation system) 3 will be described with reference to FIGS. 3 and 4. FIG. 3 is a flowchart illustrating a procedure of the motor-based heat generation (the heat generation availability determination and the heat generation) by the battery heating apparatus 3. This process is repeatedly performed mainly by the EV-CU 60 at predetermined timings. FIG. 4 is a timing chart illustrating changes in a heat generation instruction flag, an electric oil pump (EOP) flow rate, a motor instruction current, a braking instruction, and the battery temperature while the battery heating apparatus 3 is performing the motor-based heat generation (the heat generation availability determination and the heat generation). In FIG. 4, horizontal axes represent time, and vertical axes represent, from top to bottom, the heat generation instruction flag, the EOP flow rate, the motor instruction current, the braking instruction, and the battery temperature, respectively.

In step S100, whether the predetermined heat generation start conditions, which include the condition that the vehicle 1 be parked (stationary) and the condition that the temperature of the battery 72 be lower than or equal to the predetermined temperature, have been satisfied is determined. If the heat generation start conditions are not satisfied, the process temporarily suspends. If the heat generation start conditions are satisfied, on the other hand, the process proceeds to step S102 (refer to a time t1 in FIG. 4).

In step S102, the electric oil pump 83 and the like are driven to activate the heat exchange system (temperature adjusting system) 80 (refer to the time t1 in FIG. 4).

Next, in step S104, the electric brake booster 51 (hydraulic brakes 11) is driven, and electric power (current) is supplied to the FMG 21 (refer to a time t2 in FIG. 4).

Next, in step S106, whether the FMG 21 (or the wheels 10) has rotated by the predetermined angle or more is determined. If the FMG 21 (or the wheels 10) has rotated by the predetermined angle or more, the process proceeds to step S108. If the FMG 21 (or the wheels 10) has not rotated by the predetermined angle or more, on the other hand, the process proceeds to step S110.

In step S108, the supply of electric power to the FMG 21 is stopped to stop the rotation of the FMG 21 (that is, the rotation of the front wheels 10FL and 10FR) and abort the motor-based heat generation (heat generation availability determination). Various system checks (fail checks) are also performed. The process then temporarily suspends.

In step S110, on the other hand, whether a predetermined period of time has elapsed since the start of the driving of the electric brake booster 51 is determined. If the predetermined period of time has not elapsed, the process is repeatedly performed until the predetermined period of time elapses. If the predetermined period of time has elapsed, on the other hand, the process proceeds to step S112 (refer to a time t3 in FIG. 4).

In step S112, the driving of the electric brake booster 51 (hydraulic brakes 11) is stopped (refer to the time t3 in FIG. 4). In step S114, whether the FMG 21 (or the wheels 10) has rotated by the predetermined angle or more is determined. If the FMG 21 (or the wheels 10) has rotated by the predetermined angle or more, the process proceeds to step S108 described above. The supply of electric power to the FMG 21 is then stopped to stop the rotation of the FMG 21 (that is, the rotation of the front wheels 10FL and 10FR) and abort the motor-based heat generation (heat generation availability determination). The various system checks (fail checks) are also performed. The process then temporarily suspends.

If the FMG 21 (or the wheels 10) has not rotated by the predetermined angle or more, on the other hand, the process proceeds to step S116. In step S116, whether the electric power (current) supplied to the FMG 21 has reached the predetermined target electric power (current) is determined. If the electric power (current) supplied to the FMG 21 has not reached the predetermined target electric power (current), the process proceeds to step S118. If the electric power (current) supplied to the FMG 21 has reached the predetermined target electric power (current), the process proceeds to step S120 (a time t8 in FIG. 4).

In step S118, after the predetermined period of time elapses (for example, after the temperature of the electric brake booster 51 falls below the predetermined temperature), the electric brake booster 51 (hydraulic brakes 11) is driven again, and the electric power (current) supplied to the FMG 21 is increased (added on) by the predetermined amount (refer to a time t4 in FIG. 4). The process then proceeds to step S106, and steps S106 to S116 are performed again (repeatedly) (refer to times t4 to t8 in FIG. 4).

In step S120, on the other hand, the discharge flow rate of the electric oil pump 83 (oil circulation rate) is increased to increase the amount of heat (motor-generated heat) supplied to the battery 72 (refer to the time t8 in FIG. 4).

Next, in step S122, whether the temperature of the battery 72 has reached the predetermined target temperature is determined. If the temperature of the battery 72 has not reached the predetermined target temperature, a current state, that is, a state in which the driving of the electric brake booster 51 has been stopped and the predetermined target electric power (current) is supplied to the FMG 21, is maintained in step S124 (the heat generation is continuously performed).

When the temperature of the battery 72 has reached the predetermined target temperature, on the other hand, the supply of electric power to the FMG 21 is stopped in step S126, and the motor-based heat generation is terminated. The process then ends (refer to a time t9 in FIG. 4).

As described in detail above, according to the present embodiment, if the FMG 21 does not rotate (that is, the wheels 10 do not rotate) during and after the driving of the electric brake booster 51, electric power supplied to the FMG 21 is increased, and when the electric power supplied to the FMG 21 reaches the predetermined target electric power without the rotation of the FMG 21 (that is, without the rotation of the wheels 10), the state is maintained (the heat generation is performed). The motor-based heat generation, therefore, can be performed after confirming that the FMG 21 (wheels 10) is not rotating.

As a result, even when a parking gear, a parking brake, and the like are not provided for the drive system 13F that transmits the driving force of the FMG 21 to the wheels 10, the motor-based heat generation by the FMG 21 can be performed while the vehicle 1 is stationary (parked) without newly adding a dedicated parking gear, a parking brake, or the like. That is, the motor-based heat generation can be performed using the FMG 21 in addition to the RMG 22. The motor-generated heat (the amount of heat supplied to the battery 72), therefore, can be further increased.

According to the present embodiment, on the other hand, if the FMG 21 (or the wheels 10) has rotated by the predetermined angle or more while the motor-based heat generation (the heat generation availability determination and the heat generation) is being performed, the supply of electric power to the FMG 21 is immediately stopped to abort the motor-based heat generation (the heat generation availability determination and the heat generation). The rotation of the FMG 21 (that is, the rotation of the wheels 10), therefore, can be promptly and reliably stopped.

In addition, according to the present embodiment, when the temperature of the battery 72 reaches the predetermined target temperature, the supply of electric power to the FMG 21 is stopped to terminate the motor-based heat generation (the heat generation availability determination and the heat generation). Unnecessary power consumption, therefore, can be suppressed.

According to the present embodiment, when the electric power (current) supplied to the FMG 21 is increased, the discharge flow rate of the electric oil pump 83 is also increased. When the electric power supplied to the FMG 21 is small, therefore, the discharge flow rate of the electric oil pump 83 (oil circulation rate) can be decreased to prompt the increase in the temperature of the FMG 21, and when the electric power (current) supplied to the FMG 21 becomes large, the flow rate of the electric oil pump 83 (oil circulation rate) can be increased to increase the amount of heat (motor-generated heat) supplied to the battery 72.

Although an embodiment of the disclosure has been described, the disclosure is not limited to the above embodiment, and can be modified in various ways. For example, although a case where the disclosure is applied to a two-motor BEV has been described in the above embodiment as an example, the disclosure can also be applied to, for example, a BEV including only one motor (for example, only the FMG 21) and the like. That is, although a case where the disclosure is applied to an AWD BEV has been described in the above embodiment as an example, the disclosure can also be applied to, for example, two-wheel drive (2WD) BEVs. The disclosure can also be applied to fuel cell vehicles (FCVs) and the like.

Although the parking gear 14 and the EPB 17 are provided for only the drive system 13R for the rear wheels 10RL and 10RR, the parking gear 14 and the EPB 17 may be provided for only the drive system 13F for the front wheels 10FL and 10FR, instead.

Furthermore, system configuration of controllers of the EV-CU 60, the VDCU 50, and the like and distribution of the functions of the controllers are not limited to those described in the above embodiment. For example, although the wheel speed sensors 12 is coupled to the EV-CU 60 in the above embodiment, the wheel speed sensors 12 may be coupled to the VDCU 50 and transmit the detected wheel rotation speed to the EV-CU 60 via the CAN 100, instead. Furthermore, although the EV-CU 60, the PCU 70, and the VDCU 50 are communicably coupled to each other via the CAN 100 in the above embodiment, the system configuration is not limited to this mode, and may be modified (for example, integrated) in any manner in consideration of, for example, functional requirements, costs, and the like.

1. A battery heating apparatus comprising:
an electric motor configured to drive wheels via a drive system that is not provided with a parking gear and a parking brake;
hydraulic brakes comprising an electric brake booster configured to generate brake hydraulic pressure using a drive motor, the hydraulic brakes being configured to brake the wheels using the brake hydraulic pressure;
a battery configured to supply electric power to the electric motor;
a heat exchanger configured to exchange heat between the electric motor and the battery;
a rotation detector configured to detect rotation of the electric motor;
a temperature detector configured to detect temperature of the battery; and
a control unit configured to control the electric motor and the electric brake booster,
wherein the control unit is configured to perform a process comprising:
supplying, when predetermined heat generation start conditions including a condition that a vehicle be parked and a condition that the temperature of the battery be lower than or equal to a predetermined temperature are satisfied, electric power to the electric motor while driving the electric brake booster, and, after an elapse of a predetermined period of time, stopping the driving of the electric brake booster and performing a heat generation availability determination for determining whether the electric motor has rotated during and after the driving of the electric brake booster;
repeatedly performing, when the electric motor has not rotated, the heat generation availability determination while increasing the electric power to be supplied to the electric motor; and
stopping, when the power supplied to the electric motor reaches predetermined target electric power, driving the electric brake booster and performing heat generation for maintaining a state in which the predetermined target electric power is supplied to the electric motor.

2. The battery heating apparatus according to claim 1,
wherein the control unit is configured to, when the electric motor rotates by a predetermined angle or more during the heat generation availability determination or the heat generation, stop supplying electric power to the electric motor and abort motor-based heat generation comprising the heat generation availability determination and the heat generation.

3. The battery heating apparatus according to claim 2,
wherein the control unit is configured to, when the temperature of the battery reaches a predetermined target temperature, stop supplying electric power to the electric motor and terminate the motor-based heat generation comprising the heat generation availability determination and the heat generation.

4. The battery heating apparatus according to claim 3, further comprising:
an electric oil pump configured to pressurize and discharge an oil and supply the oil to the electric motor for cooling,
wherein the heat exchanger is configured to exchange heat between the oil that has cooled the electric motor and the battery, and
wherein the control unit is configured to increase a discharge flow rate of the electric oil pump as the power supplied to the electric motor is increased.

5. The battery heating apparatus according to claim 4,
wherein the electric motor comprises a first electric motor configured to drive front wheels and a second electric motor is configured to drive rear wheels,
wherein a parking gear and/or a parking brake are provided for one of a drive system configured to transmit driving force of the first electric motor to the front wheels and a drive system is configured to transmit driving force of the second electric motor to the rear wheels, and
wherein the control unit is configured to perform the motor-based heat generation using both the first electric motor and the second electric motor.
